(19) United States
(12) Patent Application Publication
(10) Pub. No.: US 2004/0002917 A1
(43) Pub. Date: Jan. 1, 2004

(54) Method and arrangement for electronically transferring an amount of money from a credit account memory

(76) Inventors: Michael Horn, Munchen (DE); Hans-Hermann Wolf, Munchen (DE)

Correspondence Address: MORRISON & FOERSTER LLP, 1650 TYSONS BOULEVARD, SUITE 300, MCLEAN, VA, 22102, US

(21) Appl. No.: 10/344,854

(22) PCT Filed: Aug. 2, 2001
(86) PCT No.: PCT/EP01/09217

(30) Foreign Application Priority Data
Aug. 18, 2000 (EP) 00117854.0

(51) Int. Cl. G06F 17/60

(52) U.S. Cl. 705/39

(57) ABSTRACT

The invention relates to a method for transferring an amount of money electronically from a credit account memory of a money transmitter to an account or into a credit account memory of a money receiver, in real time, via a telecommunications and data network.

The invention relates to a method and an arrangement for transferring an electronic sum of money from a credit memory to an account or to another credit memory via a telecommunications and data network.

Besides for use as a means of communication and a source of information for what has now become hundreds of millions of people, the Internet is becoming increasingly important as a source of shopping. Particularly trade in software, books and travel is already being carried out on the Internet in a significant proportion today, but also a broad spectrum of other goods and services is increasingly being ordered and paid for over the Internet. Paying for the relevant services on the Internet in the manner which was established originally and is still generally widespread today requires the relevant data records to be input separately in each case, at least by each party to the transaction, if not even for the individual transaction. This mode of payment thus allows the party to the transaction to see sensitive personal data and even to store them permanently.

The Internet has now also become considerably important for handling other payment transactions in the business and private sectors. Virtually all banks in industrial states offer electronic handling of account management and of payment transactions in the form of “electronic banking”.

Nevertheless, the majority of payment transactions in day-to-day life are, even today, still performed using cash or by providing transfer or direct debit orders or the like in writing, or by credit card or check card. In specific areas, for example that of mobile radio technology, electronic credits (“prepaid cards”) have also become significant, but considerable obstacles prevent this means of payment from being introduced on a widespread basis.

Altogether, it can be stated that, in the current state of development, there is an extremely confusing large number of options for paying for goods or services, and using said options in day-to-day life requires considerable alertness and requires a wide variety of media and modes of input to be dealt with. This is demanding and is also associated with diverse security risks (losing data storage media or credit media, forgetting account data and authentication codes etc.).

Besides the Internet, telecommunications—particularly mobile telecommunications—today represents an area of rapid technical and economic development and a significant source of economic growth and new social developments. For many of the people in industrial states, the mobile telephone (“mobile”) is increasingly becoming a universal communication and information instrument and is also increasingly being used to access goods and services. This development is also still hindered by insufficient opportunities for reliable and at the same time simple payment for information, goods and services ordered using a mobile.

Although solutions exist which allow the user of a mobile—with or without a prepaid card—to authorize payments, which are then processed in a conventional manner by debit procedures or credit card debiting, these methods presuppose, as do payment processing procedures which have now been introduced on the Internet, that the purchaser is creditworthy and has authority to use a credit card or a current account with an overdraft facility. In addition, these procedures have inherent time lags which have an adverse effect on the transparency and reliability of the overall processing.

The invention is therefore based on the object of specifying a method and an arrangement for simplified processing of payment transactions using a data network.

This object is achieved in terms of its method aspect by a method having the features of claim 1 and in terms of its apparatus aspect by an arrangement having the features of claim 9.

The invention encompasses the fundamental concept of specifying a largely universal payment method on the basis of an electronic credit (prepaid account or card) which can be used for payment processing in the “B2C (Business-2-Consumer) sector” and also in the “C2C (Consumer-2-Consumer) sector”, that is to say allows shopping in real and virtual shops, payment in catering or cultural establishments etc., and the “transfer” of sums of money in the private sector. It also encompasses the concept of using the opportunities of a linked telecommunications and data network in this regard, specifically the opportunity for processing in real time, in particular. In the present case, an electronic credit is understood to mean a memory content in a credit memory which can be operated via a telecommunications or data network in order to perform payment transactions—in principle regardless of whether the memory actually has a prepaid credit or whether a credit sum is not transferred until a later time.

The central piece in the proposed arrangement and in the proposed method is a transaction server which accesses a transaction database storing the data relevant for transferring prepaid credits. The transfer operation is initiated by reading a data storage medium or data terminal, storing a money sender data record which is adequate for specifically initiating the transaction, using a reader which is available with the money receiver. This reader, for its part, is connected to the transaction server via a telecommunications terminal.

As a real time method, the proposed method affords improved transparency and reliability as compared with known payment processing methods and can also be used, in particular, by people who are not granted a credit facility. The user need merely have a prepaid credit ensuring sufficient coverage of the envisaged money transfer.

In the description below and in the patent claims, the holder of the prepaid credit who wishes to transfer a sum of money and is in a (real or virtual) shop as a purchaser and in a catering establishment as a guest is referred to generally as the “money sender”. The receiver of the sum of money to be transferred, who will usually be the owner or operator of a shop or a catering or cultural establishment or the like in daily life, is referred to generally as the “money receiver” below. In addition, the money receiver and the money sender can also be applications.

Any money receiver wishing to use the opportunity to transfer money from a co-operating party's prepaid credit to his own account needs to subscribe to a service implementing the transfer of money. The subscription operation involves a data record which relates to it being stored in the transaction database (“shopping database”). The money receiver's account must be suitable for managing electronic credits; in particular, it can likewise be a prepaid account. The money receiver can use a plurality of telephone numbers and also a plurality of destination accounts for transferring money, in which case it is naturally necessary to store all the telephone numbers and account identifiers to be used for all the accounts in the shopping database (the term “account identifier” is understood in the text below to mean everything including an account number or an account code and the possibly required server address of an external server on which the account is managed). Besides the data mentioned, the money receiver data record stored in the transaction database expediently also comprises a name or company name.

As a hardware prerequisite for using the service, the money receiver requires a reader for the data storage medium used with the specific arrangement or for the money sender's suitable data terminal. This can be an inherently known card reader for chip cards or magnetic strip cards or else simply an interface for transferring transaction-related data from a memory in the aforementioned data terminal. It should expediently have an input device and an output device for inputting additional information (for example sum of money, PIN, . . . ) and for outputting information and signals relating to the transaction process (confirmation signal or terminate signal, requests for particular inputs . . . ).

Provided that the specific form of the proposed solution makes provision for the use of a data terminal by the money sender, this data terminal is preferably equipped for wireless message transmission to the reader (which is naturally in a corresponding form), particularly by means of infrared or Bluetooth transmission. Combinations of data storage medium and terminal in the money sender's possession are also possible—for example the provision of a barcode (to be read using a barcode reader available with the money receiver) containing the first money sender data record on the back of the terminal (mobile phone, handheld PC or the like) which the money sender has.

The system advantageously comprises a way of associating various people with a prepaid credit as money senders, for example the members of a family or of an organization or the employees of a company. These will expediently have personalized data storage media or data terminals which are respectively equipped with the necessary authentication means.

Besides the information relating to the money receiver, the shopping database also holds the money sender information which is required for performing the money transfer. This (second) money sender data record expediently contains the prepaid telephone number, if necessary the server address of an external server on which the prepaid credit is managed (also occasionally referred to below as “account identifier”), advantageously also the server and operator names and finally an authentication data record for at least optionally authenticating larger money transfers on a case-by-case basis.

The first money sender data record stored on the data storage medium or data terminal which the money sender uses to initiate the transfer operation comprises, in one advantageous refinement of the invention, a validation code (subsequently also referred to as VIN=Validation Number). This is, by way of example, a multidigit random number which is allocated by the operator of the corresponding service and increases security when using the data storage medium. The VIN becomes effective when a prepaid agreement has expired and the associated prepaid telephone number is activated for another account holder (and hence money sender) by the operator of the service after a certain waiting period. For this situation, it ensures that the original holder of the prepaid call number cannot continue to use the data storage medium (or the correspondingly loaded memory in his data terminal) possibly remaining with him improperly for money transfers from a credit which is no longer in his possession.

A further fundamental security component is the aforementioned authentication data record in the second money sender data record (which can be accessed in the transaction database). The authentication data record comprises, in particular, an authentication code (PIN or the like) and/or biometric data for the money sender (e.g. papillary line or retina pattern), which code and/or data is/are used for authorizing money transfers on a case-by-case basis. This code and these data are input on the reader itself or on an input unit associated therewith, are transmitted to the transaction server via the associated terminal and are compared there with the corresponding stored data. As a result of the comparison, the transaction is enabled or blocked. When the proposed solution is used in real shops, catering establishments etc., the sum of money to be transferred is preferably entered by a cash register connected to the reader, which prevents entry errors and manipulation in practice.

In one preferred implementation of the method, the aforementioned authorization steps are not performed for very small sums, but only for sums of money which exceed a predetermined threshold value. This threshold value can advantageously be set and changed by the service operator or by the money sender himself.

The proposed solution, which symbolically can also be referred to as a “prepaid shopping application”, comprises the function blocks (1) starting the money transfer method (2) debiting from the money sender and (3) crediting the money receiver. These function blocks can be executed on one and the same server or on different servers covered jointly by the term “transaction server”. The server or servers can exist centrally with one service operator or in a plurality of hardware implementations with this service operator or with a plurality of service operators. The prepaid shopping application has—as already mentioned above—access to a “shopping database” which (depending on the specific network and application concept) can likewise be provided centrally at one point, distributed over a plurality of points or else can be provided in a plurality of copies at a variety of points.

The method and arrangement take the simplest form when the money sender's prepaid credit, the money receiver's destination account and the prepaid shopping application itself are managed or operated by one and the same service operator. If this is not the case, clearing (known as such) needs to take place for the money transfer. For this operation, the documentation created in the debit and credit operation, particularly in the form of “log records”, can be used.

The proposed system affords (besides the advantages already mentioned) the considerable advantage that the electronic money held in a prepaid account can be used not only for paying for a service having a narrow specification (specifically telephone calls), but also in diverse ways for paying for goods, services, information etc. in real or in virtual sales establishments of all kinds. Prepayment for the credit gives the user strict cost control, and in principle it is not possible to get into debt unintentionally. This means that this method can be used with particular advantage for minors (or else for older people who are no longer in full possession of their mental faculties) as well, for whom there has been no comparable application to date. For paying for goods and services from different suppliers, a plurality of prepaid cards or terminals is no longer required, but rather only a single data storage medium on which a single prepaid call number is stored.

Advantages and expediencies of the invention can otherwise be found in the subclaims and in the description below of a preferred exemplary embodiment with reference to the figures, in which:

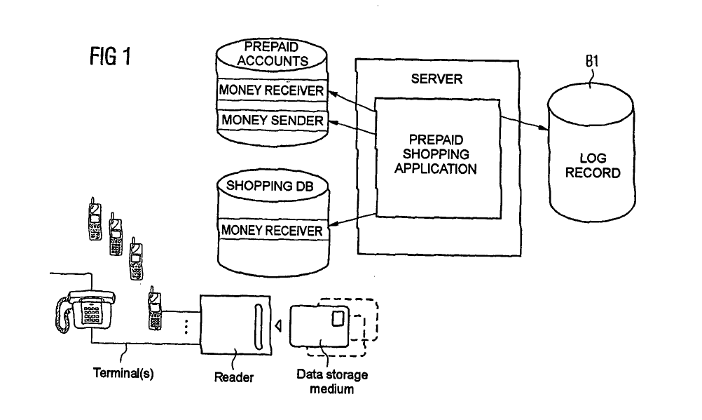

FIG. 1 shows a greatly simplified function block diagram of an embodiment of the inventive arrangement and

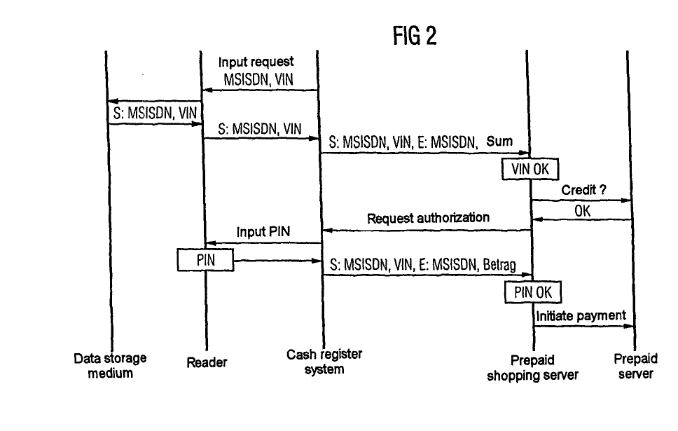

FIG. 2 shows a schematic illustration of the fundamental steps of the first function block in the proposed application for the arrangement shown in FIG. 1.

The figures are essentially self-explanatory if it is borne in mind that the acronym S:MSISDN denotes a prepaid call number for the money sender, the acronym E:MSISDN denotes the corresponding call number for the money receiver, and the acronym VIN denotes the aforementioned validation code.

To perform the money transfer, the prepaid call number (specifically mobile radio number) and the VIN of the money sender are entered from his data storage medium via the reader. The prepaid call number contains an initial string of digits which is used to identify the money transfer method. When the data storage medium has been read, the corresponding terminal therefore sets up a data link to the shopping database. (Alternatively, the shopping database can also be dialled up manually or using a preselection mode after the data storage medium has been read.)

When the connection has been set up, the following data are transmitted to the shopping database: the receiver's destination account number, the sum of money to be transferred, the money sender's prepaid call number and the VIN. If a cash register system is connected to the reader, the sum of money is entered automatically via the cash register, otherwise the sum can be entered manually using a keypad on the reader, for example.

Following transmission of the data, which started the money transfer procedure, there is a checking operation to determine whether the data storage medium is valid and the sum in the money sender's prepaid account is sufficient for the envisaged transfer operation. If both are the case, the money sender is asked to authorize debiting of the sum of money to be transferred by inputting his PIN.

As part of the checking operation, the prepaid shopping application accesses the shopping database and reads the money receiver data record and the (second) money sender data record with the information it contains regarding which server or which servers (and which operator or which operators) has/have the money receiver's and money sender's accounts. The money sender's server is identified, and, if it is a different server than that on which the prepaid shopping application is running, a real time connection to a prepaid shopping application running on this foreign server is set up.

There is then a check to determine whether the VIN stored on the money sender's data storage medium which has been read matches the VIN stored in the second money sender data record. If this is not the case, the data storage medium is invalid and the money transfer is terminated with a corresponding signal to the money receiver's terminal. If the data storage medium is valid, the prepaid shopping application on the money sender's server is sent a request to check whether the electronic credit in the money sender's prepaid account is sufficient for the envisaged money transfer. If this is not the case, the transfer is terminated with a corresponding advice signal to the money receiver's terminal. If the sum of money to be transferred is covered, it is reserved in the money sender's prepaid account.

Next, the aforementioned authorization is given by virtue of the money sender inputting the PIN on the money receiver's reader. The PIN which is input is compared with the PIN stored in the second money sender data record. If it is valid, the debit operation is initiated. If it is invalid, the transaction is terminated at this point and a corresponding advice signal is again transmitted.

The sum of money to be transferred is then debited from the money sender's prepaid account. This process is time critical and is performed in real time. If the money sender's prepaid account is on the same server as the prepaid shopping application, the credit can immediately (in real time) be reduced by the sum of money to be transferred. If the account is on a foreign server, the debit request needs to be sent to the prepaid shopping application on that server, and the debit operation is performed under that application's regime. In each case, a log record is created for the debit operation, and the money receiver is informed about the debit operation having been performed by means of the cash register system or a call or by SMS or the like.

The sum of money to be transferred is then credited to the money receiver's account, which can be a prepaid account, a real time account or a normal bank current account. This operation is not time critical but needs to take place with utmost reliability. In this case too, a distinction needs to be made between the aforementioned variants for debiting—according to whether or not the account is managed on a foreign server. A log record is also created for the credit operation.

It will be pointed out that FIG. 1 assumes that the prepaid shopping application runs on the same server as that on which prepaid accounts associated with the money receiver and the money sender are also managed. In FIG. 2, on the other hand, it is a prerequisite that at least the money sender's prepaid account is managed on a different server than the one on which the prepaid shopping application is running.

The implementation of the invention is not limited to the aforementioned examples, variants and aspects; rather, the claims likewise permit a large number of modifications for it which are within the scope of action of a person skilled in the art. In particular, the method steps described above are also possible in a different order.

1. A method for transferring an electronic sum of money from a money sender credit memory, particularly containing a prepaid credit, to an account belonging to a money receiver or to a money receiver credit memory via a telecommunications and data network in real time, in which, after
a first money sender data record, comprising at least one prepaid call number associated with the money sender credit memory in the telecommunications network, has been stored on a data storage medium belonging to the money sender or in a memory in a money sender terminal,
a second money sender data record, comprising at least the prepaid call number, an account identifier for the money sender credit memory and an authentication data record, has been stored in a transaction database,
the money receiver has subscribed to a money transfer service with a service operator and has stored a money receiver data record, comprising at least one account identifier for the account or for the money receiver credit memory and a call number for a money receiver terminal belonging to the money receiver in the telecommunications network, in the transaction database, the following method steps are carried out:
the first money sender data record is immediately read from the money sender's data storage medium or from the money sender terminal using a reader associated with the money receiver terminal,
the sum of money to be transferred is input on the reader or on an additional appliance,
a connection is set up between the money receiver terminal and a transaction server belonging to the service operator on the basis of part of the prepaid call number,
a money transfer data record, comprising at least the sum of money and the money sender's prepaid call number, is transmitted to the transaction server,
the transaction server reads the transaction database and evaluates the money receiver data record and the second money sender data record,
the sum of money is debited from the money sender credit memory, and this is documented, and
the sum of money is credited to the money receiver account or to the money receiver credit memory, and this is documented.

2. The method as claimed in claim 1, characterized in that
information about the debit and/or credit operation is transmitted to the money receiver's money receiver terminal.

3. The method as claimed in claim 1 or 2, characterized in that
prior to debiting the sum of money from the money sender credit memory, the coverage of the sum of money is checked in the money sender credit memory, and the sum of money is reserved if it is covered, or the process is terminated with signaling if there is insufficient coverage.

4. The method as claimed in one of the preceding claims, characterized in that
the first money sender data record used is a money sender data record having a validation code which is also at least part of the authentication data record in the second money sender data record, the version stored in the second money sender data record being able to be accessed and changed by a service operator which manages the money sender credit memory.

5. The method as claimed in one of the preceding claims, characterized in that
the authentication data record used in the second money sender data record is an authentication data record having an authentication code and/or having biometric data for the money sender, and, before the debit operation step, steps for authorizing said debit operation are performed, namely the following steps:
the authentication code and/or the biometric data is/are input by the money sender on an input device,
the input is transmitted to the transaction server, and
the transmitted data are compared with the data held in the second money sender data record, and a debit enable signal is output if there is a match and a debit blocking signal is output if there is no match.

6. The method as claimed in claim 5, characterized in that
the authorization steps are performed for a sum of money which exceeds a predetermined threshold value,

7. The method as claimed in one of the preceding claims, characterized by
its being performed by setting up a data link to at least one external server on which the money sender credit memory and/or the money receiver account or the money receiver credit memory are managed, the account identifier of the money receiver data record and/or the account identifier of the second money sender data record comprising a server address or server call number, and the transaction server being connected to this or these following the step of reading out the money receiver data record and the second money sender data record in order to perform the subsequent steps.

8. The method as claimed in one of the preceding claims, characterized in that
the sum of money is input autonomously by means of a cash register which co-operates with the reader.

9. The method as claimed in one of the preceding claims, characterized in that
the first money sender data record is read from the money sender's terminal by wireless message transmission, particularly by means of infrared or Bluetooth transmission.

10. The method as claimed in one of the preceding claims, characterized in that
the money receiver takes out the subscription with the service operator using a plurality of accounts and/or call numbers, the number of accounts being less than the number of call numbers, in particular, and all the corresponding account identifiers and the call numbers being stored in the money receiver data record.

11. An arrangement for transferring an electronic sum of money from a money sender credit memory, particularly containing a prepaid credit, to an account belonging to a money receiver or to a money receiver credit memory via a telecommunications and data network in real time, particularly in order to carry out the method as claimed in one of the preceding claims, which has:
at least one account management server having the money sender credit memory and the account belonging to the money receiver or money receiver credit memory,
a data storage medium belonging to the money sender or a money sender terminal storing a first money sender data record which comprises at least one prepaid call number associated with the money sender credit memory in a telecommunications network,
a money receiver terminal connected to the telecommunications and data network, a reader which is connected to the money receiver terminal and is designed for directly reading the first money sender data record from the data storage medium or from the money sender terminal,
a service operator transaction database storing a money receiver data record, which comprises at least one account identifier for the money receiver's account or money receiver credit memory and the call number of the money receiver terminal, and a second money sender data record, which comprises at least the prepaid call number, an account identifier for the money sender credit memory and an authentication data record, and
a transaction server which is connected to the transaction database and can be connected to the money receiver terminal and to the account management server or to the account management servers or is an integral part of said server or servers, for reading the money receiver data record and the second money sender data record from the transaction database, for receiving the first money sender data record and for evaluating the data records and for controlling a debit operation on the money sender credit memory and a credit operation on the money receiver account or money receiver credit memory.

12. The arrangement as claimed in claim 11, characterized in that
the transaction database and the money sender credit memory and/or the money receiver credit memory are implemented on the transaction server.

13. The arrangement as claimed in claim 11 or 12, characterized in that
the transaction server has means for documenting a debit operation and a credit operation, particularly in the form of a log record.

14. The arrangement as claimed in one of claims 11 to 13, characterized in that
the transaction server has associated telecommunication means for signalling the termination of a transaction or for signalling a debit operation and/or a credit operation at least to the money receiver's terminal.

15. The arrangement as claimed in one of claims 11 to 14, characterized in that
the telecommunications and data network comprises a mobile radio network, with, in particular, the money receiver's terminal and/or the money sender's terminal being in the form of a mobile radio terminal.

16. The arrangement as claimed in one of claims 11 to 15, characterized in that
the money sender's data storage medium is in the form of a chip card or magnetic strip card, and the money receiver's reader is in the form of a corresponding card reader.

17. The arrangement as claimed in one of claims 11 to 16, characterized in that
the money receiver's reader has a cash register for autonomously inputting the sum of money and/or an input keypad for inputting an authentication code and optionally the sum of money and/or the transaction server's server address or call number connected to it.

18. The arrangement as claimed in one of claims 11 to 15 or 17, characterized in that
the money receiver's reader has a wireless data interface for reading the first money sender data record from the money sender's terminal to the money receiver's terminal.

19. The arrangement as claimed in one of claims 11 to 18, characterized by
a plurality of terminals belonging to the money receiver which are registered with the service operator and whose call numbers are stored in the money receiver data record.

20. The arrangement as claimed in one of claims 11 to 19, characterized by
a plurality of data storage media or terminals belonging to the money sender which respectively store a valid first money sender data record.
